(19) United States
(12) Patent Application Publication
(10) Pub. No.: US 2021/0099075 A1
(43) Pub. Date: Apr. 1, 2021

(54) Loop Handoff Transient Mitigation for Multi-Loop Switch Mode Power Converters

(71) Applicant: Apple Inc., Cupertino, CA (US)

(72) Inventor: Stephen Hrinya, San Jose, CA (US)

(21) Appl. No.: 16/684,277

(22) Filed: Nov. 14, 2019

Related U.S. Application Data
(60) Provisional application No. 62/906,821, filed on Sep. 27, 2019.

(51) Int. Cl. H02M 1/42; H02M 3/07; H02M 3/158; H02M 3/28; H02M 3/335

(52) U.S. Cl. CPC H02M 1/42; H02M 3/07; H02M 3/33592; H02M 3/285; H02M 3/158

(57) ABSTRACT

A switching power converter may have a plurality of control loops, each control loop being configured to regulate a voltage or current of the converter. The multi-loop converter may be provided with a loop handoff transient mitigation circuit. The loop handoff transient mitigation circuit may be configured to modify the operating point of an inactive control loop to aid the transition from an active control loop to the inactive control loop. The loop handoff transient mitigation circuit may operate by clamping a voltage of the inactive loop to a voltage corresponding to a control voltage of the active control loop. The clamped voltage may be a control voltage of the inactive loop and/or may be a compensating capacitor voltage of the inactive control loop.

### BACKGROUND

Modern electronic devices employ a wide variety of switch mode power converters. For example, portable electronic devices, such as laptop and notebook computers, tablet computers, smart phones, and the like, may use a switching power converter (e.g., a buck converter) to convert power delivered from an external power adapter (itself another power converter) into a form suitable for charging the battery. Additional converters and converter topologies may also be used depending on the application.

At a high level, a switching power converter may include one or more switching devices and one or more passive components coupled between an input and an output of the converter. The converter may receive a voltage and current at its input and produce a converted voltage and current at its output. Many converters include two or more control loops that operate the one or more switching devices responsive to the input and output voltages and currents (or other parameters). For example, a switching converter may include a voltage control loop that operates the switching device(s) to maintain a regulated output voltage and one or more current control loops that operate the switching devices to maintain an input, output, or other current at a desired level. In general only one of the multiple control loops will be active at any given time.

Transitioning from a first operating condition in which one control loop is active to a second operating condition in which another control loop is active (described herein as a loop handoff or control loop transition) can result in undesirable transients of the regulated parameters. In general, these transients arise because the control voltage of the inactive loop that is assuming control may be very far from the existing control voltage of the active loop. In many cases the inactive loop may be at its upper or lower limit while the loop is inactive. The associated discontinuity in control signal seen by the switching apparatus can cause the aforementioned undesirable transients. Thus, what is needed in the art are improved circuits and techniques for mitigating transients associated with loop handoffs in multi-loop switch mode power converters.

### BRIEF DESCRIPTION OF THE DRAWINGS

FIG. 1 illustrates a simplified schematic diagram of a buck converter based battery charger power converter.

FIG. 2 illustrates a simplified schematic diagram of a multi-control loop converter.

FIG. 3 illustrates a control circuit for a converter including input current overshoot control.

FIGS. 4A and 4B illustrate exemplary embodiments of inter-loop compensating clamps.

FIG. 5 illustrates an exemplary error amplifier embodiment.

FIG. 6 illustrates two exemplary gain curves for alternative error amplifier embodiments.

FIG. 7 illustrates a device power system including a charger converter and control system incorporating the output voltage and input current overshoot mitigation techniques discussed herein.

FIG. 8 illustrates a device power system including a charger converter and control system incorporating the output voltage and input current overshoot mitigation techniques discussed herein.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language and examples used in this disclosure have been selected for readability and instructional purposes, and have not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

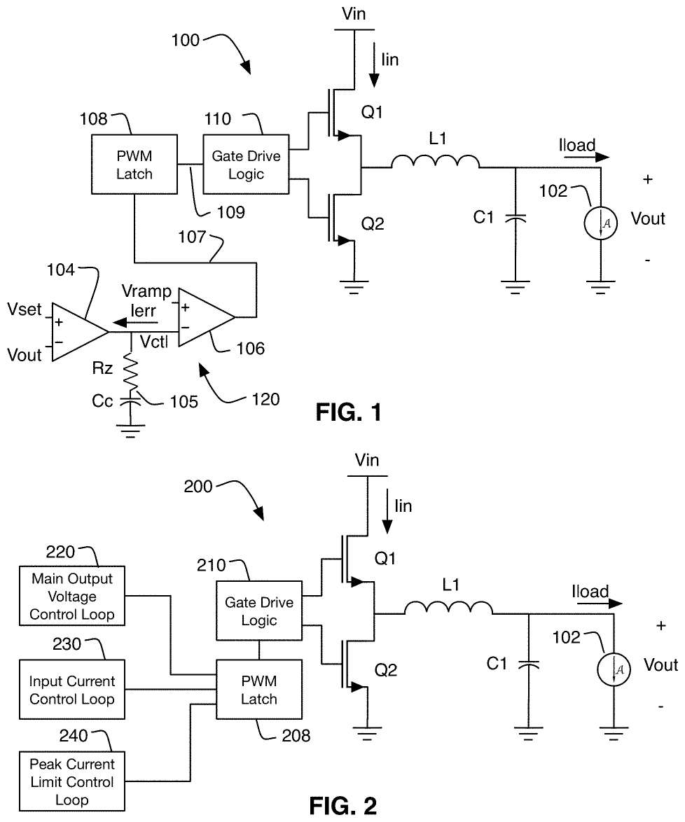

FIG. 1 illustrates a simplified schematic diagram of a buck converter based switch mode power converter 100. Throughout this document, the converter circuitry may be referred to as a converter, a buck converter, a switching converter, a switch mode converter, or other similar language as appropriate for the context. Use of various terms is intended to be consistent with usage as would be employed by one ordinarily skilled in the art for the particular context, and should not be construed as limiting unless expressly required. Converter circuit 100 receives an input voltage Vin and an input current Iin and generates an output voltage Vout. Output voltage Vout may be delivered to a load, represented by current source 102, which draws a current Iload.

In the illustrated embodiment, converter 100 is a buck converter, meaning that switches Q1 and Q2 are operated so as to reduce the input voltage Vin to an output voltage Vout that is lower than Vin. More specifically, switch Q1 may be closed to connect the input voltage Vin to the load via inductor L1 and output capacitor C1. When switch Q1 is closed, input current Iin flows through inductor L1 to output capacitor C1 and load 102. This current: (1) delivers energy to load 102, (2) stores energy in inductor L1, and (3) charges output capacitor C1. After a time period determined by the desired output voltage and output current required by load 102, switch Q1 may be opened, disconnecting the input voltage from load 102. Substantially simultaneously, switch Q2 may be closed. Closing switch Q2 allows load current Iload to continue to flow through inductor L1 and load 102. During this time period, energy stored in inductor L1 and capacitor C1 is delivered to load 102.

FIG. 1 also illustrates a simplified schematic of a main output voltage control loop 120 for converter 100. As used herein, “main loop,” “main control loop,” and similar language will refer to a control loop that regulates output voltage. A particular converter embodiment may include multiple control loops each controlling one of input voltage, output voltage, input current, output current, or other parameters of the converter. In the embodiment of FIG. 1, the main control loop 120 includes an error amplifier 104 that receives at one input (e.g., a non-inverting input) a setpoint voltage Vset, which is the desired output voltage Vout. Error amplifier 104 receives output voltage Vout at the other input (e.g., an inverting input). In some implementations, error amplifier 104 may be implemented as a transconductance amplifier the output of which Ierr, is proportional to the difference between the desired output voltage and the actual output voltage.

Providing a loop control signal Vctl for use by pulse width modulation (PWM) comparator 106 may require that the transconductance amplifier output current be delivered to an appropriate impedance. This impedance may be made up of resistor Rz and compensating capacitor Cc. The compensation network 105 comprised of resistor Rz and capacitor Cc may have component values related to the values of inductor L1 and output capacitance C1. More specifically, inductor L1 and capacitor C1 introduce a delay between when a change is made to the switching operation of switches Q1 and Q2 and when the associated change in output voltage Vout appears at the output of the converter. For reasons of control system stability, the values of resistor Rz and compensating capacitor Cc may be selected to provide an impedance that provides a frequency zero corresponding to one of the poles associated with L1/C1. Additionally, the voltage appearing across compensating capacitor Cc may be manipulated as required to facilitate smooth transitions between control loops as described in greater detail below.

Loop control signal Vctl may be provided to one input (e.g., an inverting input) of a PWM comparator 106. PWM comparator 106 may receive at its other input a ramp voltage signal Vramp. Comparator 106 may thus generate an output 107 that is low when error voltage Verr is greater than the instantaneous value of the ramp voltage signal Vramp and low when error voltage Verr is greater than the instantaneous value of ramp voltage signal Vramp. Comparator output signal 107 may be provided to the reset terminal of a PWM latch 108. PWM latch 108 may be set at the beginning of the switching signal and may be reset by PWM comparator 106 (via control voltage 107), thereby determining the timing of switches Q1 and Q2. Gate drive logic 110 may receive PWM latch output signal 109 and generate appropriate gate drive signals for the switches Q1 and Q2. In general, increasing control signals will lead to wider turn on pulses for switch Q1, which subsequently delivers more energy from the input voltage source Vin to the load.

Gate drive logic 110 may include any necessary interconnecting circuitry to allow PWM latch output signal 109 to drive switches Q1 and Q2. This may include logic circuitry to generate complementary logical gate drive signals for switches Q1 and Q2. This may also include suitable anti-cross conduction logic to prevent both switches from being turned on at the same time (which would short circuit the input). Still further, gate drive logic 110 may also include any circuits necessary to shift the voltage or current of the logical gate drive signals to match the levels required by the particular switching devices used in a given application. As a result, switches Q1 and Q2 will be operated to maintain output voltage Vout at the value determined by the setpoint voltage Vset. As a side note, it will be appreciated that the duty cycle of switch Q1 will be approximately equal to the conversion ratio of the converter, i.e., the ratio of input voltage Vin to output voltage Vout.

FIG. 2 illustrates a simplified schematic diagram of a multi-control loop converter 200 and uses like reference numbers to those discussed above with respect to FIG. 1. FIG. 2 further illustrates, in block form, three exemplary control loops. A first control loop 220 may be a main output voltage control loop as discussed above. Converter 200 may also include input current control loop 230, which may take over from main control loop 220 (or any other active control loop) as required to limit the input current Iin. Converter 200 may also include a peak current limit control loop 240 that may take over from main control loop 210 (or any other active control loop) as required to limit the peak inductor current. The exemplary control loops are given by way of example only. It will be appreciated that the inventive concepts herein are applicable to any multi-loop switch mode converter including any combination of voltage and/or current control loops. A particular embodiment need not include all or any of the specific control loops discussed herein.

With further reference to FIG. 2, PWM latch 208 may, in addition to the circuitry described above, include arbitration logic/circuitry to determine which control loop is active at any given time (i.e., which control loop is presently controlling the operation of switches Q1 and Q2). For purposes of the embodiments described herein, each control loop may be considered as including a comparator circuit that will generate a trigger signal to reset PWM latch 208 responsive to that control loop's error signal exceeding a threshold. PWM latch 208 may be configured so as to be reset by any of the respective trigger signals, and thus the control loop whose error signal first exceeds a threshold will reset the PWM latch, thereby assuming control of the converter.

The foregoing descriptions with respect to FIGS. 1 and 2 are based on simplified schematics of a converter circuit and control loop. Detailed circuit configuration, components, and parameters may be selected by an ordinarily skilled artisan to meet the particular requirements of such an embodiment. Additionally, there may be additional functionality, circuit components, or other elements included in a particular embodiment that have not been discussed in detail herein. The foregoing description is thus meant primarily as a background context for discussing the output voltage mitigation techniques discussed below.

In multi-loop controlled converters, it may be desirable to mitigate overshoot conditions that can arise when control of the converter transitions from a first, active becoming inactive, control loop to a second, inactive, becoming active control loop. As but one illustrative example, it may be desirable to minimize input current overshoot of a power converter associated with a loop handoff between main loop 220 and input current control loop 230. An exemplary problematic loading condition might include an excess load that causes the input current to reach a programmed current limit. At that time, a loop transition between the main voltage control loop and an input current control loop may occur. This loop transition may result in the input current control loop taking over from the main voltage control loop and decreasing the output voltage to maintain the input current at its limit. On removal of the excess load, a second loop handoff may occur when the main output voltage control loop retakes control (i.e., resumes regulation) from the input current control loop. In at least some embodiment, there may be a time delay between the active loop releasing control and an inactive loop taking control when the loop handoffs occur. During such delay intervals, the input current (or other regulated parameters) may experience an undesirable transient (for example, an overshoot above a corresponding predetermined limit). Discussed below are improved control circuits for multi-loop switch mode power converters that can reduce such undesirable transients associated with loop handoff.

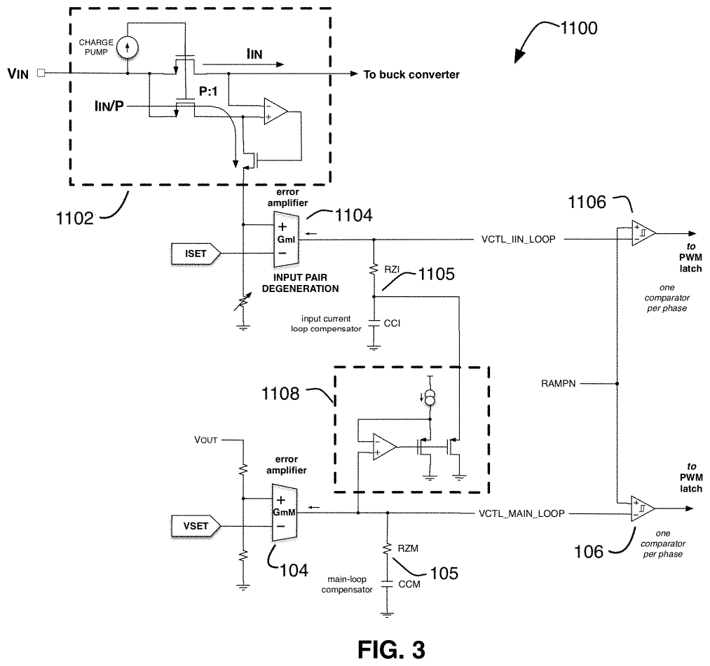

FIG. 3 illustrates a control circuit 1100 for a converter with loop handoff transient mitigation circuitry implemented for input current overshoot control. As noted above, the inventive concepts are not limited to the particular exemplary control loops provided, but rather may be used in connection with any combination of input/output voltage/current control loops. Illustrated control circuit 1100 includes a first (main) control loop configured to regulate the converter's output as described above with reference to FIG. 1. The first control loop can include voltage error amplifier 104, a compensation circuit 105 comprising compensation resistor RZM and compensation capacitor CCM, and PWM comparator 106. Additionally, control circuit 1100 can include a second control loop configured to regulate input current. Under certain operating conditions, this second control loop may take over switching control of the converter from the main loop (i.e., there may be a loop handoff from the first/main/voltage control loop to the second/auxiliary/input current control loop). The current control loop may include an error amplifier 1104 that receives a current setpoint at one input (e.g., an inverting input) and a present input current value at a second input (e.g., a non-inverting input). The present input current value may be measured by current measurement circuit 1102, which is but one example of a current measurement circuit—other current measurement circuits could also be used. Those ordinarily skilled in the art will be familiar with and capable of implementing a variety of current measurement circuits suitable for any particular application.

The output of input current error amplifier 1104 may be coupled to PWM comparator 1106 and a compensation network 1105 made up of current loop compensating resistor RZI and current loop compensating capacitor CCI. The current loop compensation network is similar to the voltage loop compensation network discussed above and serves to match the control loop to the characteristics of the converter and power system itself to ensure operational stability. In at least some embodiments, current loop compensating capacitor CCI may be selected based upon the output capacitance seen by the converter. In any case, the resulting voltage VCTL_Iin_Loop may be provided to a comparator 1106 that receives the same input ramp signal as PWM comparator 106. The output of the comparator may then be coupled to the PWM latch 108/208 as discussed above.

Control circuit 1100 may optionally include additional control loops beyond those shown. For example, the control circuit could also include an output current and input voltage control loop. Each of the control loops may be designed so as to take over operation from the main voltage control loop when necessary. Each loop may have its own input signal and its own error amplifier. The output of the error amplifier may then be provided to a corresponding compensating network and a corresponding comparator that couples to the PWM latch circuitry. The control loops may be designed so that their output voltages deviate to the maximum power supply rail voltage when not in control so that they do not interfere with the operation of the active control loop. In some embodiments one or more control loops may share a comparator, with the output signals (i.e., control signals) from the respective error amplifiers being “OR'ed” together in a way that the control signal having the lowest voltage will “win” and become the input into the respective comparator.

With respect to control circuit 1100 illustrated in FIG. 3, the main voltage control loop (lower) and input current control loop (upper) each have their own respective comparators 106 and 1106. However, these comparators receive the same PWM ramp signal RAMPN for comparison. Thus, whichever is the lower of the VCTL_Main_Loop signal or the VCTL_Iin_Loop signal will trigger its respective comparator first, which will then trigger the PWM latch to terminate the current switching stage. In multi-phase power converters each switching phase may have its own ramp signal that is compared against the loop control signal (common to all phases) to provide the gate drive timing for that phase.

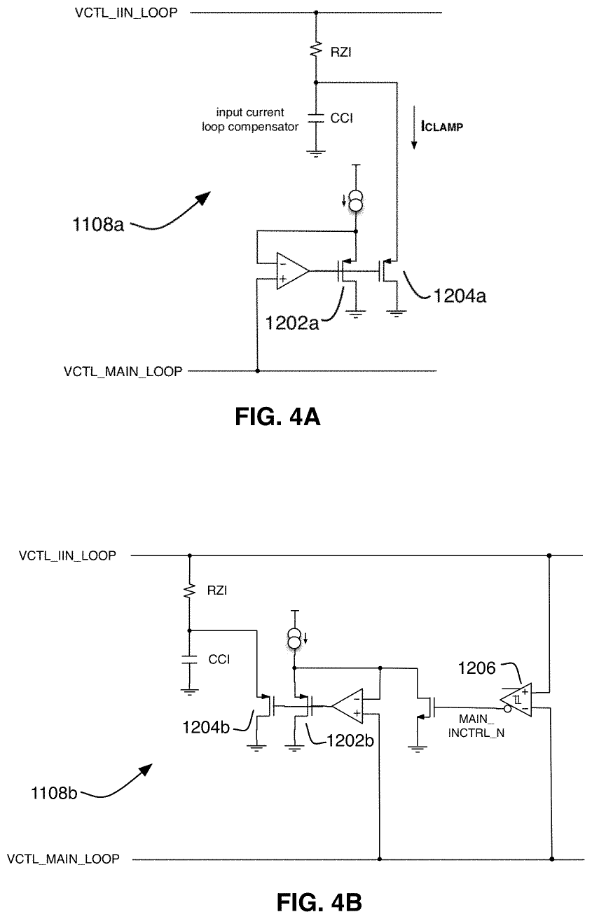

Control circuit 1100 may also include one or more loop handoff transient mitigation circuits, such as inter-loop compensating clamps 1108. Two exemplary clamp embodiments 1108a and 1108b are illustrated in FIGS. 4A and 4B, respectively. Inter-loop compensating clamp 1108 serves to clamp the voltage of input current loop compensating capacitor CCI to a value corresponding to the main voltage control loop signal. The clamp circuit preloads the capacitor voltage, but also indirectly defines a clamped voltage for the control loop equal to Vcap+Iclamp·RZ. With reference to FIG. 4A and clamp circuit 1108a, as discussed above, the loop compensation networks have low frequency zeroes used to cancel out a pole caused by the large output capacitance of the converter. Active clamp 1108a may feed-forward the control voltage of the active loop onto the compensating capacitor of the IBUS control loop. More specifically, the main loop control voltage VCTL_Main_Loop may be replicated by a PMOS source 1202. A duplicate PMOS 1204 may be used as a clamp for the compensating capacitor 3I of the Ibus current loop. This clamping of the current loop compensating capacitor voltage and control voltage will not change the overall loop dynamics of the current control loop when it is operating. Rather, it just provides a more favorable initial condition that aids the handoff from main output voltage loop control to current loop control. As illustrated further below, additional clamps may be added to aid handoff between other loops.

FIG. 4B illustrates an alternative embodiment of the inter-loop compensating clamp 1108b. As in the previous embodiment, an active clamp may feed forward the control voltage of the active loop onto the compensating capacitor of the IBUS current control loop. As discussed above, this also indirectly defines a clamped control voltage for the control loop. An additional comparator 1206 may be configured to determine which loop is in control (the lowest control voltage controls the PWM comparator/latch). The main loop control voltage may be replicated at PMOS source 1202b. A duplicate PMOS 1204b may be used as a clamp for the current loop compensating capacitor CCI. As a result, when the bus current control loop takes control, the compensating capacitor will have been pre-loaded to a voltage near to that of the prior controlling loop (e.g., the main voltage control loop) and the current loop control voltage will also have been indirectly clamped to a higher voltage. Additionally, when the current control loop takes control (i.e., following the handoff), the comparator logic may disable the feed-forward clamp, meaning the PMOS gate goes high. As a result, the disabled clamp voltage moves well above the normal operating voltage range of the loop. As in the embodiment discussed above with respect to FIG. 4A, additional clamps may be added to aid hand off between other loops.

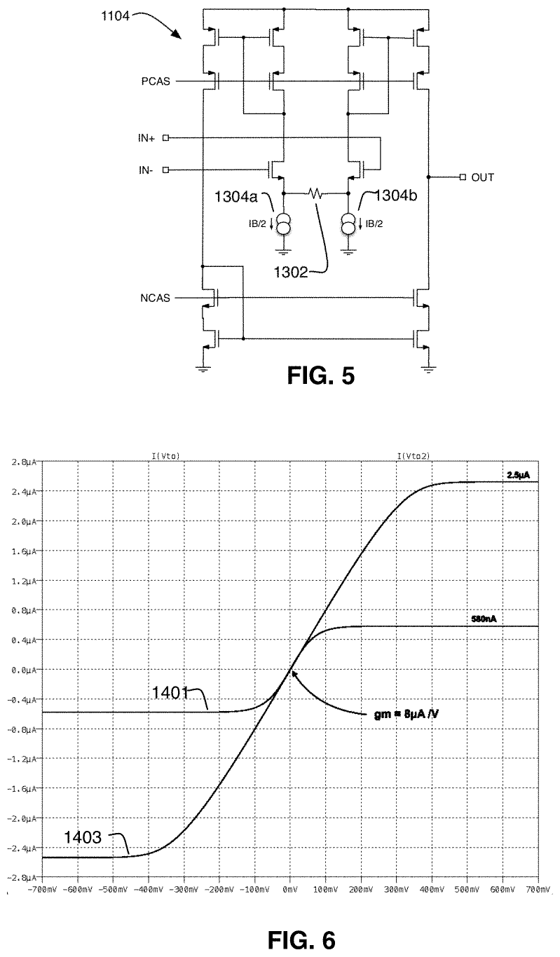

The afore-mentioned benefits of loop handoff transient mitigation circuits may optionally be enhanced by error amplifier degeneration of one or more of the control loop error amplifiers. FIG. 5 illustrates an exemplary error amplifier embodiment, and FIG. 6 illustrates two exemplary gain curves. FIG. 5 illustrates an exemplary embodiment of current loop error amplifier 1104. Error amplifier 1104 is a transconductance amplifier having a topology known in the art. The value of resistor 1302 may be selected to provide the desired gain for amplifier 1104. With reference to FIG. 6, curve 1401 illustrates exemplary input differential voltage (horizontal axis) versus output current (vertical axis) for a typical prior art embodiment. Curve 1401 illustrates a small signal gain of 8 uA/V in a small linear region between about −50 mV and +50 mV input voltage.

Conversely, curve 1403 illustrates input differential voltage versus output current for a input pair source degenerated embodiment in which the current values of the current sources 1304a and 1304b are increased. The small signal operating region in which amplifier 1104 exhibits constant/linear gain may be extended, e.g. from about −300 mV to +300 mV. It will be appreciated that the exemplary gains and operating ranges may be selected as appropriate for a given embodiment, but that what is important is that current values for the current sources 1304a and 1304b and appropriate corresponding resistance value of resistor 1302 may be selected to increase the linear operating range of the amplifier while maintaining the desired gain. It will further be appreciated that these principles may be extended to different topologies of error amplifiers. The increase of the linear operating range of the error amplifier increases the corresponding maximum current from the amplifier and thus the amplifier output voltage when the corresponding loop is not in control. This can allow the inactive control loop's control voltage to be well above the voltage of the active control loop so that the inactive loop does not interfere with normal operation of the active loop.

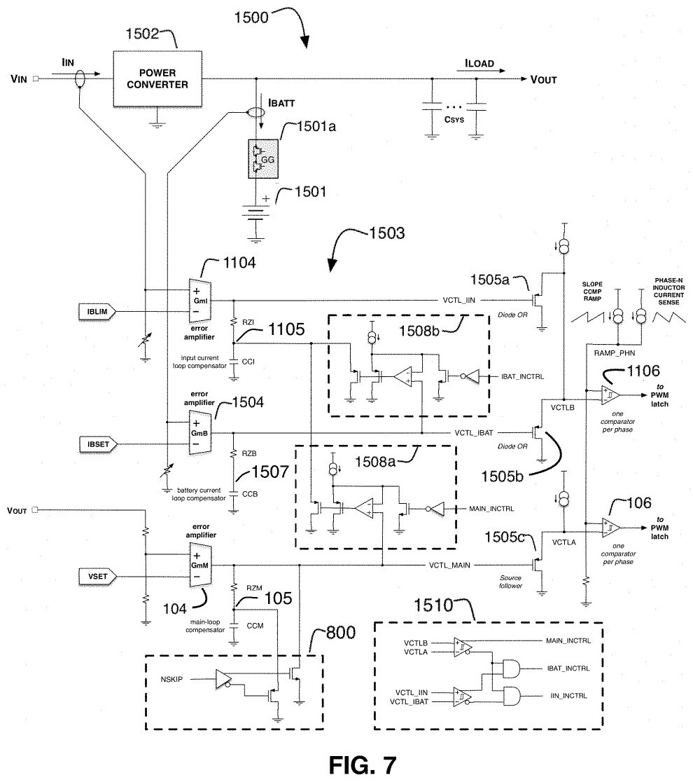

FIG. 7 illustrates a switch mode power converter system 1500 including a switch mode converter 1502 and control system 1503 incorporating loop handoff transient mitigation circuitry as described above. Exemplary power converter system 1500 may be used as a battery charger, although, as noted above, the inventive concepts may be applied to a switch mode power converter used for any application. Converter 1502 receives an input voltage Vin and an input current Iin and converts these to an output voltage Vout and an output current including Iload (delivered to the system load) and a battery current Ibatt, which may be used to charge a battery 1501 through battery disconnect 1501a. As discussed above, converter 1502 may have a large output capacitance Csys, which may include multiple capacitances throughout an electronic device.

Illustrated control system 1503 includes three control loops similar to those discussed above. A main control loop (lower) includes voltage error amplifier 104 and may serve to regulate the output voltage Vout of the converter. A battery current control loop (middle) includes battery current error amplifier 1504 and may serve to regulate battery current. For example, during battery charging, a battery management unit (BMU) may dictate a value of battery charging current that necessitates changes to the normal voltage of the output voltage bus. An input current control loop (upper) includes input current error amplifier 1104 and may operate above to keep input current Iin from exceeding a specified limit value. Additional control loops may optionally be provided, such as an input voltage control loop. For applications other than battery charging, various control loops may be omitted and/or control loops appropriate to such application may be included.

In each control loop, the output of the error amplifier may be coupled to a compensating network that provides a zero matching a pole associated with the system capacitance Csys to provide control system stability. More specifically, main voltage loop error amplifier 104 couples to a compensation network 105 made up of resistor RZM and capacitor CCM. Battery current error amplifier 1504 couples to a compensation network 1507 made up of resistor RZB and capacitor CCB. Input current error amplifier 1104 couples to a compensation network 1105 made up of resistor RZI and capacitor CCI. Each compensation network may be connected to a loop handoff transient mitigation circuit, which may, for example, be implemented as a voltage clamp of the corresponding compensator capacitor as discussed above.

Additionally, the error amplifier output of each control loop may be coupled to a comparator that may then be coupled to the PWM latch as discussed above. More specifically, main voltage loop error amplifier 104 may be coupled to comparator 106. Similarly, battery current error amplifier 1504 and input current error amplifier 1104 may be coupled to comparator 1106. In the illustrated embodiment, the two current control loops are coupled by diode OR circuits made up of PMOS devices 1505a and 1505b, although it should be appreciated that other OR logic or separate comparators for each loop could also be provided. Additionally, main voltage control signal VCTL_Main (i.e., the output of the main voltage loop error amplifier) is coupled to PWM comparator 106 by a source follower 1505c, so that the voltage level incorporates an additional diode drop to match the voltage levels of the other control signals. As a result, for a given control voltage, each loop will cause the same switching duty cycle for converter 1502.

As noted above, each control loop includes a compensation network, one or more of which may include a clamp circuit, including, for example clamp circuits used to mitigate control loop transitions. In the illustrated embodiment, main voltage control loop may include clamp circuit 800 discussed in Applicant's co-pending U.S. patent application Ser. No. ______, entitled “Peak Voltage Overshoot Control For Switch Mode Power Converters, filed concurrently herewith, which is hereby incorporated by reference in its entirety. To briefly summarize that application, transitioning to PFM operation for voltage overshoot mitigation may advantageously include clamping the compensation network to ease the transition out of PFM mode back into PWM mode.

As a further example, input current control loop can include a first clamp circuit 1508a, which may operate as discussed above with respect to input control limit circuit clamp 1108. Clamping the input current compensating capacitor 31 to the main voltage control loop output voltage can mitigate transients associated with loop handoff from the main voltage loop to the input current control loop. In some applications, this may advantageously reduce input current overshoot. Additionally, the input current control loop can include clamp circuit 1508b, which may operate similarly to clamp 1508a, but instead clamps the input current loop compensating capacitor to the control output of the battery current control loop. This will mitigate transients associated with a loop handoff between these two loops.

When a given control loop is coupled to more than one loop handoff transient mitigation circuit, additional measures may be taken to determine which one is active at any given time. For example, because the input current compensating capacitor has two clamps, a mechanism may be provided for restricting operation to only the loop handoff transient mitigation circuit corresponding to the active control loop. Active loop detection circuit 1510 may receive as inputs the two current control loop output signals VCTL_Iin and VCTL_Ibat, as well as the two comparator inputs VCTLA and VCTLB. From these four signals, the illustrated exemplary logic including various comparators and AND gates can generate three output signals indicating which loop is in control. Loop handoff transient mitigation circuits 1508a and 1508b may be respectively activated/deactivated by these symbols as shown. As a result, the input current loop compensating capacitor CCI may be clamped to the output voltage of whichever of the main voltage control loop and the battery current control loop is active. By extension, the control voltage of the input current loop will be clamped to a higher but corresponding voltage. It will be appreciated that the illustrated detection logic 1510 and activation signals are exemplary only, and that the ordinarily skilled artisan could construct any of a variety of circuits that would perform the same function.

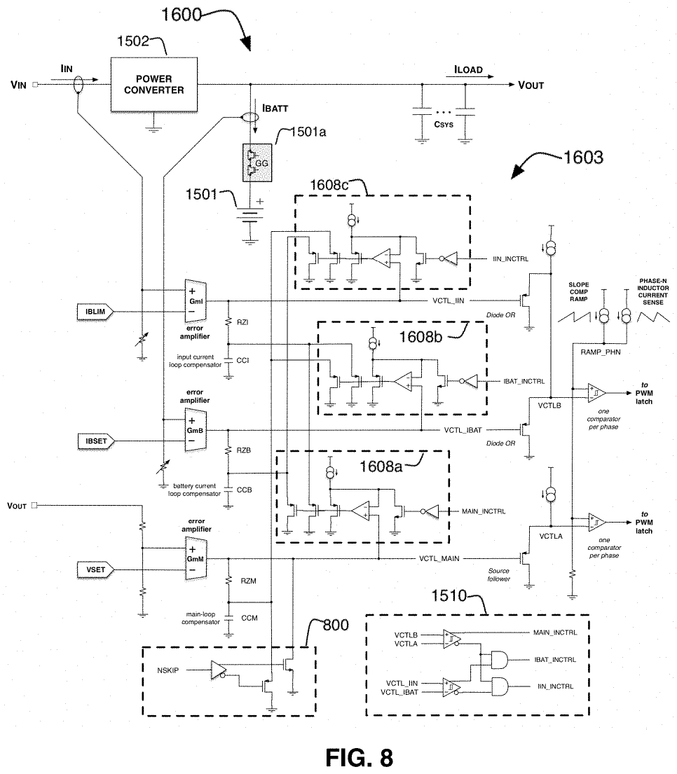

It will further be appreciated that additional loop handoff transient mitigation circuits could be provided as illustrated in FIG. 8. FIG. 8 illustrates a device power system 1600 including a converter 1502 (as discussed above) and control system 1603 incorporating the output voltage and input current overshoot mitigation techniques discussed above. Converter 1502 receives an input voltage Vin and an input current Iin and converts these to an output voltage Vout and an output current including Iload (delivered to the system load) and a battery current Ibatt, which may be used to charge a battery 1501 through battery disconnect 1501a. (Again, the illustrated converter includes battery charging functionality, but the concepts herein may be applied to switch mode converters for any of a variety of applications.) As discussed above, converter 1502 may have a large output capacitance Csys, which may include multiple capacitances throughout an electronic device.

Illustrated control system 1603 includes three control loops along the same lines as discussed above. The main control loop (lower), battery current control loop (middle), and input current control loop (upper) each include error amplifiers, compensation circuits, and comparators as discussed above. As with the aforementioned embodiments, additional control loops may optionally be provided, such as an input voltage control loop. In the embodiment of FIG. 8, each compensation network includes a loop handoff transient mitigation circuit.

In the illustrated embodiment, each control loop includes a compensation network, each of which may be coupled to a corresponding loop handoff transient mitigation circuit. By way of example, the main voltage control loop may include clamp circuit 800 discussed above with respect to FIG. 7. To summarize that discussion, transitioning to PFM operation for voltage overshoot mitigation may advantageously include clamping the compensation network to ease the transition out of PFM mode back into PWM mode. Additionally, loop handoff transient mitigation circuits 1608a, 1608b, and 1608c may be operative when the main loop, battery current loop, or input current loop, respectively are in control.

Thus, when the main voltage loop is in control, loop handoff transient mitigation circuit 1608a may be activated to clamp the compensation capacitors of the two current loops to the control voltage of the main loop error amplifier. Similarly, when the battery current control loop is active, loop handoff transient mitigation circuit 1608b may be activated to clamp the compensation capacitors of the input current loop and the main voltage loop to the control voltage of the battery current loop error amplifier. Similarly, when the input current control loop is active, loop handoff transient mitigation circuit 1608c may be activated to clamp the compensation capacitors of the main voltage loop and the battery current loop to the control voltage of the input current loop error amplifier. The control voltages of the inactive loops will be indirectly clamped to corresponding higher values determined by the impedances of the respective compensation networks. Activation of the respective clamp circuits may be enabled or disabled by active loop detector circuit 1510, which was discussed above with respect to FIG. 7. As in that embodiment, the illustrated comparator/logic gate configuration is exemplary and other circuit structures could also be used for the detection and clamp circuit activation. Such other structures could include digital circuitry such as connections of logic gates, flip flops and the like, microcontroller or microprocessor circuits, etc.

Described above are various features and embodiments relating to output voltage and input current overshoot limitation in switching power converters. Such circuits may be used in a variety of applications but may be particularly advantageous when used in conjunction with charger circuits employed in electronic devices having relatively large output capacitance loads. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A circuit comprising:
a switching converter including one or more switching devices, the switching converter being configured to receive an input voltage and an input current and deliver an output voltage and an output current;
a control circuit configured to operate the one or more switching devices, the control circuit including two or more control loops, each control loop configured to regulate a current or a voltage of the switching converter, wherein only one of the two or more control loops is active at a given time; and
a loop handoff transient mitigation circuit configured to modify operation of an inactive control loop during a transition from an active control loop to the inactive control loop, wherein the loop handoff transient mitigation circuit includes a clamp configured to clamp a voltage of the inactive control loop to a value corresponding to a control voltage of the active control loop.

2. The circuit of claim 1 wherein the voltage of the inactive control loop is a control voltage of the inactive control loop.

3. The circuit of claim 1 wherein the voltage of the inactive control loop is a compensating capacitor voltage of the inactive control loop.

4. The circuit of claim 1 wherein a first control loop is an output voltage control loop and a second control loop is an input current control loop.

5. The circuit of claim 1 wherein one or the at least two control loops is a battery current control loop configured to regulate a battery current.

6. The circuit of claim 1 wherein:
a first control loop of the at least two control loops includes a first error amplifier configured to generate a first control voltage responsive to a difference between a first circuit parameter regulated by the first control loop and a first setpoint;
the first control voltage is delivered to a first comparator that generates pulse width modulation signals for control of the one or more switching devices;
a second control loop of the at least two control loops includes a second error amplifier configured to second control voltage responsive to a difference between a second circuit parameter regulated by the second control loop and a second setpoint; and
the second control voltage is delivered to a second comparator that generates pulse width modulation signals for control of the one or more switching devices.

7. The circuit of claim 6 wherein the first comparator and the second comparator are separate comparators.

8. The circuit of claim 6 wherein at least one of the first and second error amplifiers includes at least one current source and at least one resistor selected to provide an extended linear gain small signal operating region.

9. A method of reducing loop handoff transients in a switching power converter having at least two control loops each configured to regulate a current or a voltage of the switching converter, the method comprising:
determining which of the at least two control loops is an active control loop;
responsive to the determination, activating one or more clamp circuits to clamp a voltage of one or more inactive control loops to a value corresponding to a control voltage of the active control loop.

10. The method of claim 9 wherein the at least two control loops includes an input current control loop configured to regulate an input current of the power converter.

11. The method of claim 9 wherein the at least two control loops includes a battery current control loop configured to regulate a battery current output from the power converter.

12. The method of claim 9 wherein the at least two control loop includes an output voltage control loop.

13. The method of claim 9 wherein the clamped voltage of one or more inactive control loops is a control voltage of the inactive control loop.

14. The method of claim 9 wherein the clamped voltage of one or more inactive control loops is a voltage across a compensating capacitor of the inactive control loop.

15. A control circuit for a switching power converter, the control circuit comprising:
two or more control loops, each control loop configured to regulate a current or a voltage of the switching converter, wherein only one of the two or more control loops is active at a given time; and
a loop handoff transient mitigation circuit configured to modify operation of an inactive control loop during a transition from an active control loop to the inactive control loop, wherein the loop handoff transient mitigation circuit includes a clamp configured to clamp a voltage of the inactive control loop to a value corresponding to a control voltage of the active control loop.

16. The control circuit of claim 15 wherein the voltage of the inactive control loop is a control voltage of the inactive control loop.

17. The control circuit of claim 15 wherein the voltage of the inactive control loop is a compensating capacitor voltage of the inactive control loop.

18. The control circuit of claim 15 wherein a first control loop is an output voltage control loop and a second control loop is an input current control loop.

19. The control circuit of claim 15 wherein one or the at least two control loops is a battery current control loop configured to regulate a battery current.

20. The control circuit of claim 15 wherein:
a first control loop of the at least two control loops includes a first error amplifier configured to generate a first control voltage responsive to a difference between a first circuit parameter regulated by the first control loop and a first setpoint;
the first control voltage is delivered to a first comparator that generates pulse width modulation signals for control of the one or more switching devices;
a second control loop of the at least two control loops includes a second error amplifier configured to second control voltage responsive to a difference between a second circuit parameter regulated by the second control loop and a second setpoint; and
the second control voltage is delivered to a second comparator that generates pulse width modulation signals for control of the one or more switching devices.
